(19) United States
(12) Patent Application Publication
(10) Pub. No.: US 2023/0320334 A1
(43) Pub. Date: Oct. 12, 2023

(54) Fish Hook Insertion Assembly

(71) Applicant: John Kent, La Marque, TX (US)

(72) Inventor: John Kent, La Marque, TX (US)

(21) Appl. No.: 17/714,662

(22) Filed: Apr. 6, 2022

(51) Int. Cl. A01K 83/06; A01K 91/18

(52) U.S. Cl. CPC A01K 83/06; A01K 91/18

(57) ABSTRACT

A fish hook insertion assembly includes a fish hook that has a leader which is attached to the fish hook. A grapple is provided that has a shaft portion and a handle portion. The shaft portion has a pointed end and the shaft portion is elongated such that the shaft portion can be extended into a mouth of a bait fish thereby facilitating the pointed end to penetrate outwardly through the bait fish at a point located proximate an anus of the bait fish. A slot is integrated into the shaft portion and the slot engages the leader to pull the leader through the bait fish when the grapple is pulled outwardly from the mouth of the bait fish. In this way the fish hook can be pulled partially into the bait fish to facilitate the bait fish to be employed for fishing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fish hook devices and more particularly pertains to a new fish hook device for placing a bait fish on a fishing hook. The device includes a fish hook and a leader that is attached to the fish hook. The device includes a grapple comprising a shaft portion and a handle portion, and the shaft portion has a slot integrated therein. The shaft portion is insertable into a mouth of a bait fish and outwardly through an anus of the bait fish. The leader is attached to the slot in the shaft portion and the grapple is pulled outwardly from the mouth of the bait fish thereby drawing the bait hook into the bait fish.

### (2) Description of Related Art Including Information Disclosed Under 37 CFR 1.97 and 1.98

The prior art relates to fish hook devices including a fish hook baiter that includes a first tube slidably engaging a second tube and a biasing member. The prior art discloses a fish hook baiter that includes a first pin, a sleeve with a pair of bulbous portions that is slidable onto the first pin and a second pin that includes a grapple with engages the sleeve. The prior art discloses a fish hook baiter that includes a shaft with a slot and a tubular grip positioned around the shaft. The prior art discloses a fish hook baiter that includes a shaft with a recess in a distal end of the shaft for engaging a barb of a fish hook and a tubular grip positioned around the shaft. The prior art discloses a fish hook baiter that includes a shaft with a flattened end and a slot integrated into the flattened end and a tubular grip positioned around the shaft.

### BRIEF SUMMARY OF THE INVENTION

An embodiment of the disclosure meets the needs presented above by generally comprising a fish hook that has a leader which is attached to the fish hook. A grapple is provided that has a shaft portion and a handle portion. The shaft portion has a pointed end and the shaft portion is elongated such that the shaft portion can be extended into a mouth of a bait fish thereby facilitating the pointed end to penetrate outwardly through the bait fish at a point located proximate an anus of the bait fish. A slot is integrated into the shaft portion and the slot engages the leader to pull the leader through the bait fish when the grapple is pulled outwardly from the mouth of the bait fish. In this way the fish hook can be pulled partially into the bait fish to facilitate the bait fish to be employed for fishing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fish hook insertion assembly according to an embodiment of the disclosure.

FIG. 2 is a perspective in-use view of an embodiment of the disclosure showing a grapple being extended through a bait fish.

FIG. 3 is a perspective in-use view of an embodiment of the disclosure showing a grapple being drawn outwardly from a bait fish and a leader on a fish hook being drawn through the bait fish.

FIG. 4 is a perspective in-use view of an embodiment of the disclosure showing a bait hook being seated in a bait fish.

FIG. 5 is a perspective view of a grapple of an embodiment of the disclosure.

### DETAILED DESCRIPTION OF THE INVENTION

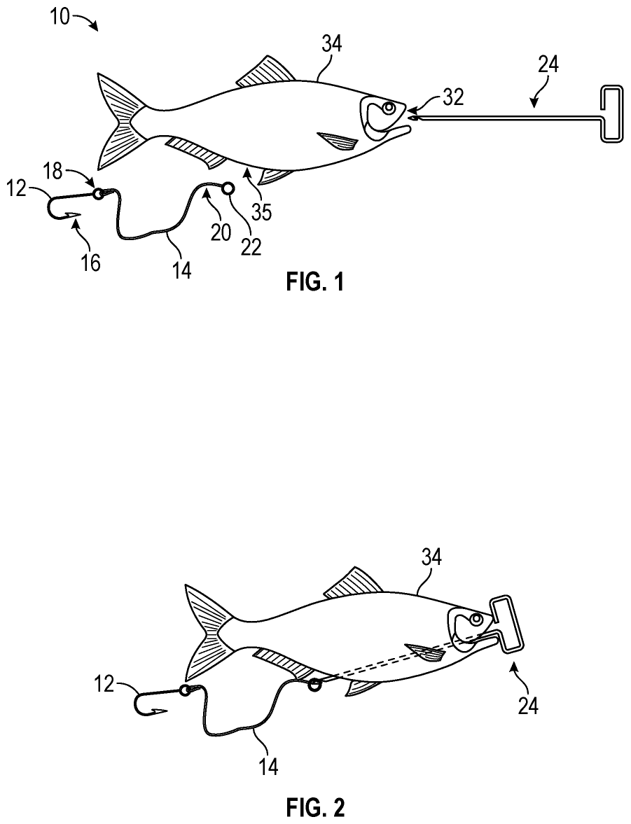

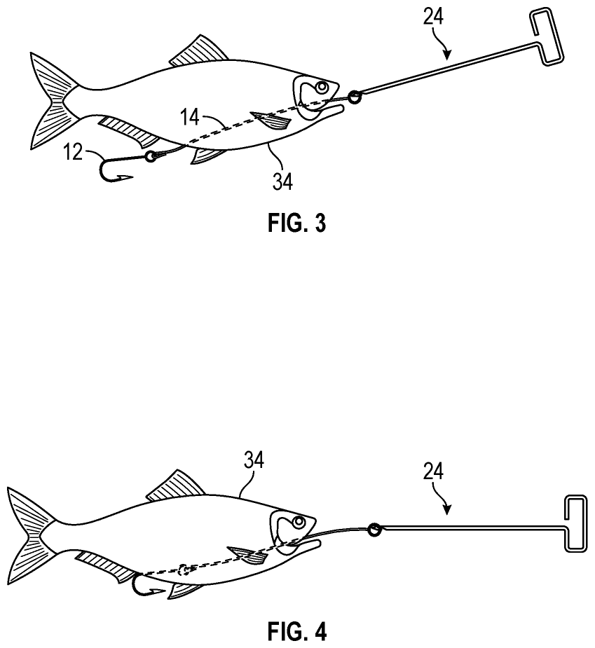

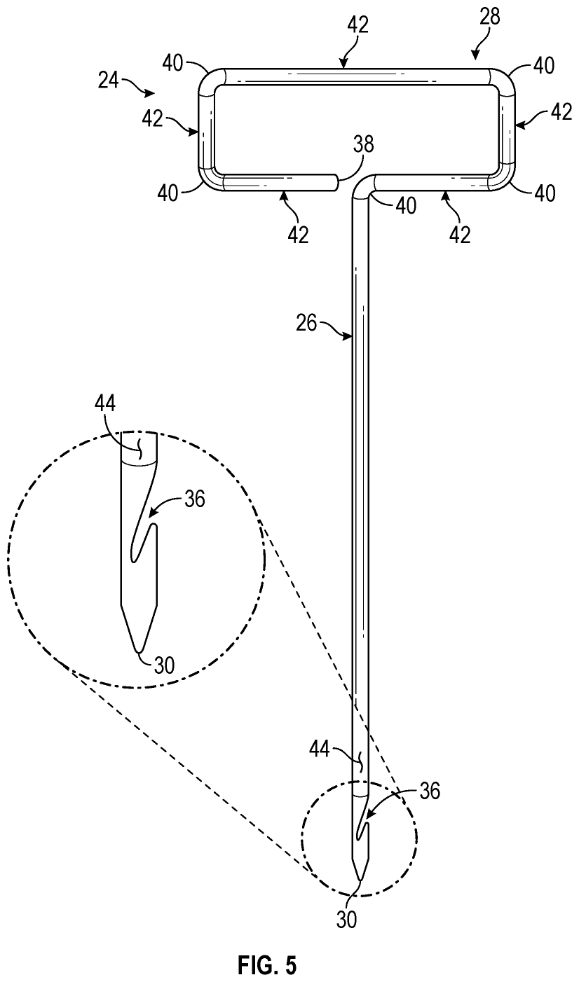

With reference now to the drawings, and in particular to FIGS. 1 through 5 thereof, a new fish hook device embodying the principles and concepts of an embodiment of the disclosure and generally designated by the reference numeral 10 will be described.

As best illustrated in FIGS. 1 through 5, the fish hook insertion assembly 10 generally comprises a fish hook 12 that has a leader 14 which is attached to the fish hook 12. The fish hook 12 has a barb 16 and an eyelet 18. The leader 14 is threaded through the eyelet 18 and the leader 14 has a distal end 20 with respect to the eyelet 18, and a ring 22 is coupled to the distal end 20. The fish hook 12 may be a fish hook that is commonly employed to fish for sharks or other large pelagic salt water fish. Additionally, the leader 14 may be a leader of any conventional design that is commonly employed in salt water fishing.

A grapple 24 is provided that has a shaft portion 26 and a handle portion 28. The shaft portion 26 has a pointed end 30 and the shaft portion 26 is elongated thereby facilitating the shaft portion 26 to be extended into a mouth 32 of a bait fish 34. Furthermore, the pointed end 30 penetrates outwardly through the bait fish 34 at a point located proximate an anus 35 of the bait fish 34. A slot 36 is integrated into the shaft portion 26 and the slot 36 engages the leader 14 when the shaft portion 26 is inserted through the bait fish 34. The grapple 24 pulls the leader 14 through the bait fish 34 when the grapple 24 is pulled outwardly from the mouth 32 of the bait fish 34 thereby facilitating the fish hook 12 to be pulled partially into the bait fish 34. In this way the fish hook 12 facilitates the bait fish 34 to be employed for fishing with minimal risk of injuring 22 a user's finger as is common with the traditional method of bating a fish hook 12.

The grapple 24 has a distal end 38 with respect to the pointed end 30 of the shaft portion 26. The grapple 24 has a series of bends 40 that are spaced apart from each other and are distributed from the distal end 38 of the grapple 24 toward the pointed end 30 of the shaft portion 26. The series of bends 40 defines a plurality of sections 42 of the handle portion 28 that is each perpendicularly oriented with each other having each of the sections 42 defining a respective side of a rectangle. The slot 36 extends into an outer surface 44 of the shaft portion 26 at a point that is located adjacent to the pointed end 30 of the shaft portion 26. The slot 36 extends along a line that is oriented at an angle with an axis extending between the pointed end 30 of the shaft portion 26 and the handle portion 28 thereby inhibiting the ring 22 from being removed from the slot 36 when the grapple 24 is pulled through the bait fish 34.

In use, the shaft portion 26 of the grapple 24 is extended into the mouth 32 of the bait fish 34 and outwardly through the anus 35 of the bait fish 34. The ring 22 on the leader 14 is positioned in the slot 36 in the shaft portion 26. The grapple 24 is pulled outwardly through the mouth 32 of the bait fish 34 until the fish hook 12 is seated in the bait fish 34 having the barb 16 pointing toward the mouth 32 of the bait fish 34 and having the leader 14 extending outwardly through the mouth 32 of the bait fish 34. The ring 22 on the leader 14 is removed from the slot 36 in the shaft portion 26 and the ring 22 is attached to a fishing line to employ the bait fish 34 for shark fishing.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fish hook insertion assembly for routing a hook and leader through a bait fish for game fishing, said assembly comprising:
a fish hook having a leader being attached to said fish hook; and
a grapple having a shaft portion and a handle portion, said shaft portion having a pointed end, said shaft portion being elongated thereby facilitating said shaft portion to be extended into a mouth of a bait fish thereby facilitating said pointed end to penetrate outwardly through the bait fish at a point located proximate an anus of the bait fish, said grapple having a slot being integrated into said shaft portion, said slot engaging said leader when said shaft portion is inserted through the bait fish thereby facilitating said grapple to pull the leader through the bait fish when said grapple is pulled outwardly from the mouth of the bait fish thereby facilitating said fish hook to be pulled partially into the bait fish wherein said fish hook is configured to facilitate the bait fish to be employed for fishing.

2. The assembly according to claim 1, wherein said grapple has a distal end with respect to said pointed end of said shaft portion, said grapple having a series of bends being spaced apart from each other and being distributed from said distal end of said grapple toward said pointed end of said shaft portion such that said series of bends defines a plurality of sections of said handle portion each being perpendicularly oriented with each other having each of said sections defining a respective side of a rectangle.

3. The assembly according to claim 1, wherein said slot extends into an outer surface of said shaft portion at a point located adjacent to said pointed end of said shaft portion.

4. The assembly according to claim 3, wherein:
said fish hook has a barb and an eyelet, said leader being threaded through said eyelet, said leader having a distal end with respect to said eyelet, said leader having a ring being coupled to said distal end;
said shaft portion has a pointed end; and
said slot extends along a line being oriented at an angle with an axis extending between said pointed end of said shaft and said handle portion thereby inhibiting said ring from being removed from said slot when said grapple was pulled through the bait fish.

5. A fish hook insertion assembly for routing a hook and leader through a bait fish for game fishing, said assembly comprising:
a fish hook having a leader being attached to said fish hook, said fish hook having a barb and an eyelet, said leader being threaded through said eyelet, said leader having a distal end with respect to said eyelet, said leader having a ring being coupled to said distal end; and
a grapple having a shaft portion and a handle portion, said shaft portion having a pointed end, said shaft portion being elongated thereby facilitating said shaft portion to be extended into a mouth of a bait fish thereby facilitating said pointed end to penetrate outwardly through the bait fish at a point located proximate an anus of the bait fish, said grapple having a slot being integrated into said shaft portion, said slot engaging said leader when said shaft portion is inserted through the bait fish thereby facilitating said grapple to pull the leader through the bait fish when said grapple is pulled outwardly from the mouth of the bait fish thereby facilitating said fish hook to be pulled partially into the bait fish wherein said fish hook is configured to facilitate the bait fish to be employed for fishing, said grapple having a distal end with respect to said pointed end of said shaft portion, said grapple having a series of bends being spaced apart from each other and being distributed from said distal end of said grapple toward said pointed end of said shaft portion such that said series of bends defines a plurality of sections of said handle portion each being perpendicularly oriented with each other having each of said sections defining a respective side of a rectangle, said slot extending into an outer surface of said shaft portion at a point located adjacent to said pointed end of said shaft portion, said slot extending along a line being oriented at an angle with an axis extending between said pointed end of said shaft portion and said handle portion thereby inhibiting said ring from being removed from said slot when said grapple was pulled through the bait fish.
